(19) United States
(12) Patent Application Publication
(10) Pub. No.: US 2008/0069369 A1
(43) Pub. Date: Mar. 20, 2008

(54) Microphone and stereo audio monitor combination with four contact plug connector

(75) Inventor: Medford Alan Dyer, San Diego, CA (US)

Correspondence Address: PATENT LAW OFFICE OF DAVID G. BECK, P. O. BOX 1146, MILL VALLEY, CA, 94942, US

(73) Assignee: Ultimate Ears, LLC, Irvine, CA (US)

(21) Appl. No.: 11/522,220

(22) Filed: Sep. 15, 2006

(51) Int. Cl. H04B 3/00

(52) U.S. Cl. 381/77

(57) ABSTRACT

An audio monitor/microphone combination coupled to a four contact plug connector is provided. Exemplary audio monitors include ear buds, in ear monitors, over-the-head headsets, over-the-ear headsets, clip-on headsets, and behind-the-neck headsets. Exemplary microphones include boom-mounted microphones, earphone integrated microphones, microphones located on (or integrated within) the headset cable, and lanyard mounted microphones. The plug connector is configured such that the tip contact region corresponds to the left-hand speaker channel input, the second contact region adjacent to the tip contact region corresponds to the right-hand speaker channel input, the third contact region adjacent to the second contact region corresponds to the microphone output, and the fourth contact region adjacent to the third contact region corresponds to both the speaker ground and the microphone ground. Insulating rings are interposed between each pair of contact regions. Preferably an adaptor is included with the audio monitor/microphone combination as part of an accessory kit.

### FIELD OF THE INVENTION

The present invention relates generally to audio monitors and, more particularly, to an audio device accessory that combines stereo audio monitors with a microphone.

### BACKGROUND OF THE INVENTION

Currently the audio industry is undergoing dramatic changes. These changes are due in large part to the rapid proliferation of a wide variety of portable audio systems such as CD players, MP3 players, ATRAC3 players, WMA players, AM/FM radios, satellite receivers, DVD players, media centers and personal computers. These devices use various media (e.g., CDs, tape, flash memory, hard drives, etc.) to store content that may be obtained by live broadcast (AM/FM/satellite) or by connecting to any of a variety of content providers via the Internet, phone lines, etc.

In addition to the effects of having a wide variety of available music players, audio formats and media types, technology convergence has added another level of complexity to the audio industry. It has become commonplace to have a single device that contains both an audio player such as an MP3 player and a cell phone. The same device may also include video capabilities, a camera, and/or Internet and text messaging capabilities.

As device complexity increases, it becomes increasingly difficult to provide accessories that are compatible with more than a single manufacturer's devices and, in some instances, compatible with more than a single device from a single manufacturer. Some incompatibility issues arise due to differences in device form factor. For example, batteries are designed to provide the desired output power for the desired time period while fitting within the allotted space within the device. Other incompatibility issues are due to the lack of an industry standard. Still other incompatibility issues occur when manufacturers attempt to retain market share by forcing the end users of their products to purchase accessories from them in order to insure compatibility with the previously purchased device.

Audio monitors, vital to the enjoyment of any audio product, are capable of a wide range of performance depending upon the monitors' design as well as the audio components used in the design. Additionally, audio monitors can be configured in any of a variety of arrangements including ear buds, in ear monitors, and over-the-head or behind-the-neck headsets. As a result, the end users of many audio devices often wish to replace the original audio monitors that accompanied their device when purchased in order to achieve improved audio performance and/or obtain a design more suitable for their intended use. Unfortunately if the audio monitors are combined with another accessory, for example a microphone, differences between device and monitor/microphone interfaces may require the user to purchase a different monitor/microphone combination for each device as well as whenever a device is replaced. Thus, the lack of monitor/microphone combination interchangeability leads to undue user expense, user confusion, and unnecessary accessory duplication. Accordingly, what is needed in the art is a microphone and stereo monitor combination that is compatible with a wide variety of audio devices. The present invention provides such a device.

### SUMMARY OF THE INVENTION

The present invention provides an audio monitor/microphone combination coupled to a four contact plug connector, preferably a 3.5 millimeter plug connector. Exemplary audio monitors include ear buds, in ear monitors, over-the-head headsets, over-the-ear headsets, clip-on headsets, and behind-the-neck headsets. Exemplary microphones include boom-mounted microphones, earphone integrated microphones, microphones located on (or integrated within) the headset cable, and lanyard mounted microphones. The plug connector is configured such that the tip contact region corresponds to the left-hand speaker channel input, the second contact region adjacent to the tip contact region corresponds to the right-hand speaker channel input, the third contact region adjacent to the second contact region corresponds to the microphone output, and the fourth contact region adjacent to the third contact region corresponds to both the speaker ground and the microphone ground. Insulating rings are interposed between each pair of contact regions. When the audio monitor/microphone combination is used with a non-microphone enabled device such as an MP3 player, the third and fourth contact regions are shorted together.

In at least one embodiment, an adaptor is included with the audio monitor/microphone combination as part of an accessory kit. The adaptor is either a single piece adaptor or a multi-piece adaptor. The adaptor includes a jack assembly configured to accept the plug connector of the audio monitor/microphone combination. The adaptor also includes an audio device connector configured to mate to a specific interface corresponding to a particular audio device, for example a specific CD player, MP3 player, ATRAC3 player, WMA player, AM/FM radio, satellite receiver, DVD player, media center, personal computer, and/or a cell phone.

A further understanding of the nature and advantages of the present invention may be realized by reference to the remaining portions of the specification and the drawings.

### BRIEF DESCRIPTION OF THE DRAWINGS

FIG. 1 is an illustration of an audio monitor/microphone combination in accordance with the invention;

FIG. 2 is a detailed illustration of the plug connector shown in FIG. 1;

FIG. 3 is an illustration of a one piece adaptor; and

FIG. 4 is an illustration of a multi-piece adaptor.

### DESCRIPTION OF THE SPECIFIC EMBODIMENTS

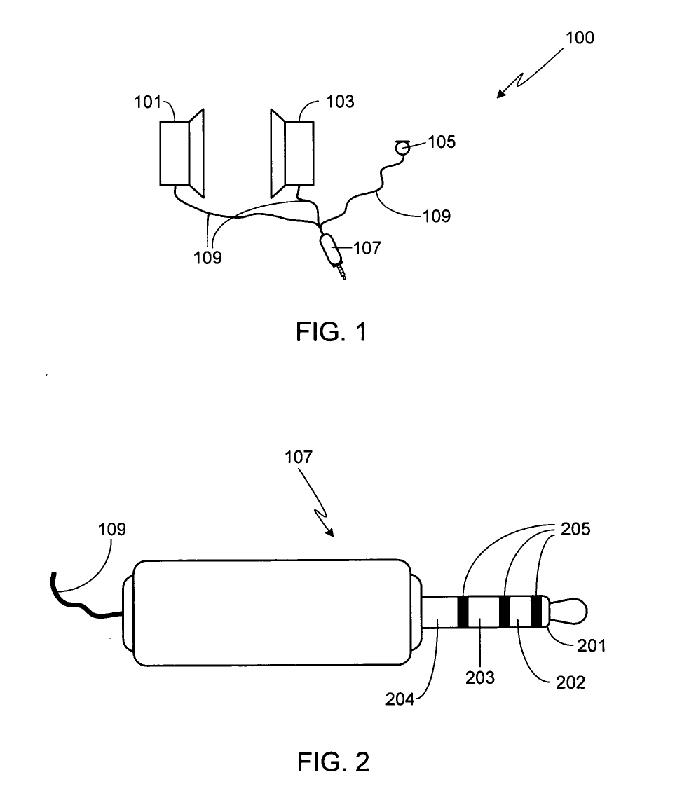

FIG. 1 is an illustration of an audio monitor/microphone combination 100 in accordance with the invention. The system includes a pair of audio monitors 101 and 103, also referred to herein as earphones, and a microphone 105. The audio monitors and the microphone are electrically connected to a plug connector 107 via cables 109.

FIG. 2 is a detailed illustration of plug connector 107. As shown, plug connector 107 includes four contact regions 201-204 separated by three electrically insulating rings 205. Plug connector 107 is configured such that tip contact region 201 corresponds to the left-hand speaker channel input, contact region 202 corresponds to the right-hand speaker channel input, contact region 203 corresponds to the microphone (+ve) output, and contact region 204 corresponds to both the speaker ground and the microphone ground. Although other sizes can be used, preferably plug connector 107 is a standard 3.5 millimeter (i.e., miniature) plug.

By using a standard 3.5 millimeter plug configured such that the tip contact region 201 is the left-hand channel, contact region 202 is the right-hand speaker channel and the sleeve (i.e., region 204) is the ground, plug connector 107 can be coupled to the miniature jack of any non-microphone enabled audio device which uses the standard audio output configuration. During such use, microphone 105 remains unconnected and preferably contact region 203 (i.e., microphone +ve output) is electrically connected to ground (i.e., contact region 204).

In order to use monitor/microphone combination 100 with an audio device that also includes a microphone input, for example a cell phone, plug 107 is coupled to a single jack of the device that includes both a microphone input and a stereo audio output. Clearly the jack must include contacts that are arranged to correspond to contact regions 201-204, specifically a tip contact corresponding to contact region 201 that provides the left-hand channel audio output, a second contact corresponding to contact region 202 that provides the right-hand channel audio output, a third contact corresponding to contact region 203 that accepts the microphone (+ve) output, and a fourth contact corresponding to contact region 204 that accepts both microphone ground and speaker ground.

Accordingly, a monitor/microphone combination in accordance with FIGS. 1 and 2 can be used with any standard audio output only device (e.g., MP3 player) utilizing a miniature jack or with any audio output/microphone input device (e.g., cell phone with MP3 capabilities) that includes a suitably configured 3.5 millimeter jack. Furthermore, adaptors can be used to extend the usefulness of monitor/microphone combination 100. Preferably such adaptors, or at least one such adaptor, is provided with monitor/microphone combination 100, for example in a pre-packaged headphone/microphone system.

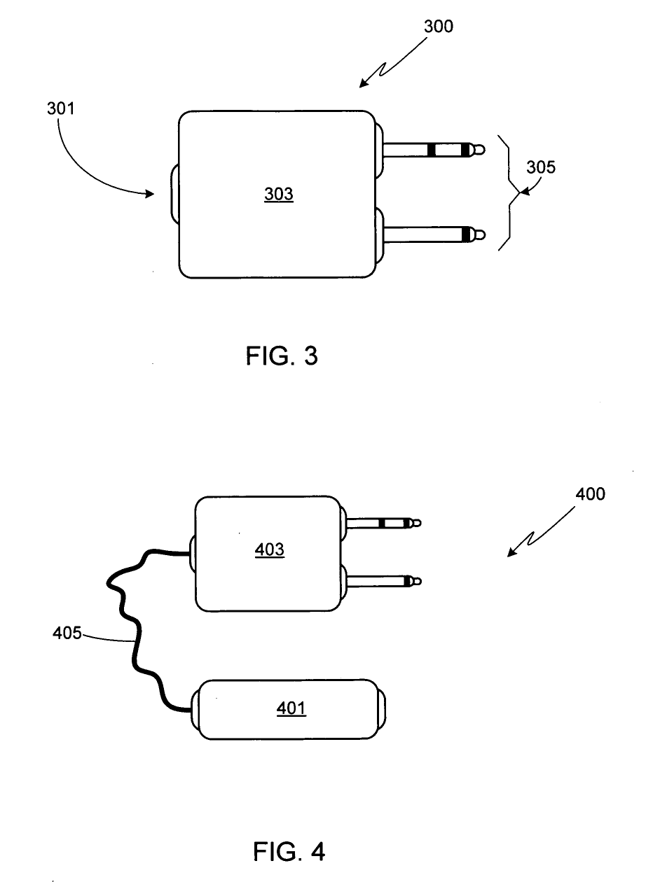

Adaptors for use with monitor/microphone combination 100 are preferably either single piece adaptors as shown in FIG. 3, or multi-piece adaptors as shown in FIG. 4. Adaptor 300 includes a 3.5 millimeter jack 301 within adaptor body 303 as well as a plug connector 305 that is configured to connect to the intended audio device (not shown). Adaptor 400 includes a 3.5 millimeter jack assembly 401, a plug connector 403 configured to connect to the intended audio device (not shown) and a cable 405 coupling jack assembly 401 to plug connector 403. Regardless of the adaptor style, the wiring within the adaptor reroutes the audio and microphone connections in order to make monitor/microphone combination 100 compatible with the intended device (e.g., a CD player, MP3 player, ATRAC3 player, WMA player, AM/FM radio, satellite receiver, DVD player, media center, personal computer, and/or a cell phone). This re-routing of the wiring may occur within the adaptor body of the single piece adaptor or within either the jack assembly or the plug connector of the multi-piece adaptor. It will be appreciated that the plug connector shown in FIGS. 3 and 4 is only intended to illustrate, not limit, the invention. For example, although plug connectors 305 and 403 utilize dual plug arrangements, a compatible connector can use a single plug connector with a different contact arrangement or of a different size (e.g., 2.5 millimeter) from that of plug 107. Alternately, a compatible connector can use a different type of connector (e.g., USB A-type connector, USB B-type connector, USB mini-B connector, a connector compatible with a specific manufacturer's device, etc.).

It will be appreciated that the present invention is not limited to a specific type or arrangement of earphones. Thus, earphones 101/103 are intended to be illustrative of any type of earphone including, but not limited to, ear buds, in ear monitors (i.e., canal phones), over-the-head headsets, over-the-ear headsets, clip-on headsets, and behind-the-neck headsets. Similarly, the present invention is not limited to a specific type or arrangement for the microphone. Thus, microphone 105 is intended to be illustrative of any type of microphone including, but not limited to, a boom-mounted microphone attached to the headset, a microphone integrated within an earphone, a microphone located on (or integrated within) a headset cable, and a microphone mounted within a lanyard.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. An audio device accessory comprising:
a pair of earphones;
a microphone; and
a 3.5 millimeter plug connector electrically connected to said pair of earphones and said microphone, said plug connector further comprising:
a tip contact region electrically connected to a left-hand channel audio input of said pair of earphones;
a second contact region adjacent to said tip contact region, said second contact region electrically connected to a right-hand channel audio input of said pair of earphones;
a third contact region adjacent to said second contact region, said third contact region electrically connected to a microphone output of said microphone;
a fourth contact region adjacent to said third contact region, said fourth contact region electrically connected to a ground of said microphone and to a ground of said pair of earphones;
a first electrically insulating ring interposed between said tip contact region and said second contact region;
a second electrically insulating ring interposed between said second contact region and said third contact region; and
a third electrically insulating ring interposed between said third contact region and said fourth contact region.

2. An audio device accessory kit comprising:
a pair of earphones;
a microphone;
a plug connector electrically connected to said pair of earphones and said microphone, said plug connector further comprising:
a tip contact region electrically connected to a left-hand channel audio input of said pair of earphones;
a second contact region adjacent to said tip contact region, said second contact region electrically connected to a right-hand channel audio input of said pair of earphones;
a third contact region adjacent to said second contact region, said third contact region electrically connected to a microphone output of said microphone;
a fourth contact region adjacent to said third contact region, said fourth contact region electrically connected to a ground of said microphone and to a ground of said pair of earphones;
a first electrically insulating ring interposed between said tip contact region and said second contact region;
a second electrically insulating ring interposed between said second contact region and said third contact region; and
a third electrically insulating ring interposed between said third contact region and said fourth contact region; and
at least one adaptor, said adaptor comprising:
a jack assembly configured to accept said plug connector; and
an audio device connector configured to mate to a specific audio device interface corresponding to at least one specific audio device, wherein said jack assembly is electrically connected to said audio device connector.

3. The audio device accessory kit of claim 2, wherein said plug connector is a 3.5 millimeter plug connector.

4. The audio device accessory kit of claim 2, wherein said audio device connector is comprised of a stereo audio input connector.

5. The audio device accessory kit of claim 4, wherein said audio device connector is further comprised of a microphone output connector.

6. The audio device accessory kit of claim 2, wherein said at least one specific audio device is selected from the group consisting of CD players, MP3 players, ATRAC3 players, WMA players, AM/FM radios, satellite receivers, DVD players, media centers, personal computers, and cell phones.

7. The audio device accessory kit of claim 2, wherein said at least one adaptor is comprised of a plurality of adaptors, wherein the audio device connector corresponding to each of said plurality of adaptors is configured to mate to a different audio device interface.

8. The audio device accessory kit of claim 2, wherein said pair of earphones is comprised of a pair of ear buds.

9. The audio device accessory kit of claim 2, wherein said pair of earphones is comprised of a pair of in ear monitors.

10. The audio device accessory kit of claim 2, wherein said pair of earphones further comprises an over-the-head headset.

11. The audio device accessory kit of claim 2, wherein said pair of earphones further comprises an over-the-ear headset.

12. The audio device accessory kit of claim 2, wherein said pair of earphones further comprises a clip-on headset.

13. The audio device accessory kit of claim 2, wherein said pair of earphones further comprises a behind-the-neck headset.

14. The audio device accessory kit of claim 2, wherein said microphone is comprised of a boom-mounted microphone.

15. The audio device accessory kit of claim 2, wherein said microphone is comprised of an earphone integrated microphone.

16. The audio device accessory kit of claim 2, wherein said microphone is comprised of a cable mounted microphone.

17. The audio device accessory kit of claim 2, wherein said microphone is comprised of a lanyard mounted microphone.

18. The audio device accessory kit of claim 2, wherein said at least one adaptor further comprises an adaptor body member, wherein said jack assembly is at least partially contained within said adaptor body member and wherein said audio device connector is coupled to said adaptor body member.

19. The audio device accessory kit of claim 2, wherein said at least one adaptor is a multi-piece adaptor, and wherein said at least one adaptor is further comprised of an adaptor cable electrically connecting said jack assembly to said audio device connector.
